(19) United States
(12) Patent Application Publication
(10) Pub. No.: US 2010/0061917 A1
(43) Pub. Date: Mar. 11, 2010

(54) METHOD FOR SEPARATING GASEOUS CO2 CONTAINED IN A GAS MIXTURE

(75) Inventors: Alain Seron, Vienne en Val (FR); Fabian Delorme, Orleans (FR); Christian Fouillac, Beaugency (FR)

Correspondence Address: YOUNG & THOMPSON, 209 Madison Street, Suite 500, Alexandria, VA, 22314, US

(73) Assignee: B.R.G.M. BUREAU DE RECHERCHES GEOLOGIQUES ET MINIERES, PARIS CEDEX 15 (FR)

(21) Appl. No.: 12/524,459

(22) PCT Filed: Jan. 24, 2008
(86) PCT No.: PCT/FR2008/000087

§ 371 Date: Nov. 18, 2009

(30) Foreign Application Priority Data
Jan. 24, 2007 (FR) 07 00482

(51) Int. Cl. C01B 31/20

(52) U.S. Cl. 423/437.1

(57) ABSTRACT

A method for separating the gaseous CO2 contained in a gas mixture, includes: the step of suspending in a liquid phase a solid absorbent capable of trapping the gaseous CO2; the step of dispersing the gas mixture into the liquid phase, the step being carried out at a temperature ranging from the liquid phase solidification temperature to the evaporation temperature, with the limits excluded, and under a pressure ranging from the atmospheric pressure to 10 bars, with the limits included.

The present invention relates to a method for separating the gaseous CO₂ contained in a gas mixture.

The separation of gaseous CO₂ contained in a gas mixture is of interest in many fields of application. A particular example is the fight against global warming, a field in which the trapping of greenhouse gases is crucial. Another example is the purification of CO₂ for commercial sale as well as the cleanup of gaseous industrial waste.

Various methods, both physical and chemical, are known for separating CO₂ from a gas mixture, most notably for trapping and/or purifying the CO₂. A widely used technique is based on the use of amines, more precisely on the use of the solvent monoethanolamine (cf. U.S. Pat. No. 4,477,419). This method, although interesting, has disadvantages in terms of transport due to the nature of the solvent used. In addition, many impurities such as NOₓ and SOₓ degrade amines and thus decrease the method's yield.

Other approaches call upon mineral traps whose capacity is used to support, in an adequate porosity, in a gaseous phase, the physisorption or capillary condensation of gaseous CO₂ (cf. Yong et al., Separation and Purification Technology 26 (2002) 195-205). These traps most notably consist of aluminas, zeolites, activated carbon or hydrotalcite minerals. However, a problem of this technique is the need to use the high pressures and high temperatures required to generate capillary condensation and desorption.

A recent technique is also in use, namely anti-sublimation, in which the operation is carried out at atmospheric pressure by directly passing the vapour phase to the solid phase of CO₂ on the external surface of refrigerating exchangers at temperatures between −80° C. and −110° C. (cf. FR-2,820,052 and FR-2,851,936). This method also requires the use of a significant amount of energy.

Another approach involves passing the stream of the gas mixture from which certain components are sought to be separated across a membrane made of a material with a permeability that is a function of the component that is sought to be isolated during this crossing (cf. Vallières and Favre, Journal of Membrane Science 244 issues 1-2 (2004) 17-23). A number of mineral and polymer materials have been used to constitute such a membrane. This technique has the disadvantage of providing effective treatment only at low gas flow rates.

In addition, American patent U.S. Pat. No. 2,823,765 divulges a method for separating a gas mixture containing one or more gases that can be adsorbed by an adsorbent. This method consists in bringing into contact the gaseous mixture with an adsorbent in suspension in a liquid, at high pressures. The adsorbent, in particular activated carbon, is incompatible with the liquid; carbon dioxide is cited as a gas to which the method can apply.

Lastly, the Applicant proposed in the patent FR 2,893,516 to separate and/or purify gases of which some are likely to form anionic species in aqueous phase by LDH (layered double hydroxide) solids or mixed oxides resulting from thermal treatment of LDHs.

The aim of the present invention is to remedy the disadvantages of the techniques of the art by proposing an effective, low-cost method for separating gaseous CO₂ contained in a gaseous mixture.

To this end, the present invention has as an aim a method for separating the gaseous CO₂ contained in a gas mixture comprising:

a step of suspending in a liquid phase a solid absorbent capable of capturing gaseous CO₂, and,

a step of dispersing the gas mixture in the liquid phase, said step being carried out at a temperature between the liquid-phase solidification temperature and vaporization temperature, with the limits excluded, and at a pressure between atmospheric pressure and 10 bars, with the limits included.

The invention is based on the surprising observation, verified experimentally by the inventors, that, during the dispersion of a gas mixture in a liquid phase, the quantity of CO₂ trapped by a solid absorbent in suspension in a liquid phase is much greater than that retained by the same solid in a gaseous phase.

The inventive method is even more interesting in that it generates a higher yield under conditions of ambient temperature and pressure, or close to ambient conditions, and is thus highly advantageous from an economic perspective.

Preferably, the dispersion of the solid is carried out:

in an aqueous solution: for example, pure water or a saline solution;

in an alcohol: for example ethanol, propanol or ethylene glycol; or,

in a ketone; for example, acetone.

According to an advantageous embodiment of the invention, the dispersion of the gas mixture is carried out in the form of bubbles in the liquid. The smaller the dispersion bubbles, the better the homogenisation and the diffusion of the gases in the liquid.

Preferably, the dispersion step is carried out at a temperature between 0° C. and 30° C. and at a pressure between, with the limits included, atmospheric pressure (Patm) and 3 bars, more preferentially between Patm and 1.5 bars, even more preferentially between Patm and 1.2 bars (thus with slight overpressure). Advantageously, the dispersion is carried out under conditions of ambient pressure and temperature.

In particular, the solid absorbent is selected equally among:

a carbonaceous material such as, for example, activated carbon or carbon nanotubes;

an oxide, for example silicates such as zeolites, clays, mesoporous silicas, manganese oxides, pumice, perlite or diatomite;

a phosphate or a phosphonate;

an hydroxide such as, for example, the layered double hydroxides such as quintinite-3T or hydrotalcite.

Advantageously, the method includes an additional step of recovering the captured gaseous CO₂.

The combination of the trapping steps and the recovery steps enable purification of the CO₂.

The recovery step preferably comprises a step of lowering the partial pressure of the gas to be trapped introduced into the liquid phase, this step being achieved either by lowering the partial pressure of CO₂ (in particular by recirculating, in the reactor saturated with CO₂, a stream of gas depleted of CO₂ from a capture reactor in operation) or by use of a weak vacuum pressure at most equal to 0.2 bar with respect to the capture pressure, or by shutting off circulation of the gas containing CO₂. Recovery of captured CO₂ can also be achieved by a step of raising the temperature of the liquid phase, preferably at most 30° C. beyond the temperature at which capture takes place, without bringing the liquid to a boil.

Lastly, the method can include in an iterative fashion a cycle comprised of a step of dispersion of the gas mixture and a recovery step.

Below are described, as non-limiting examples, various ways of executing the present invention, in reference to the annexed drawings in which:

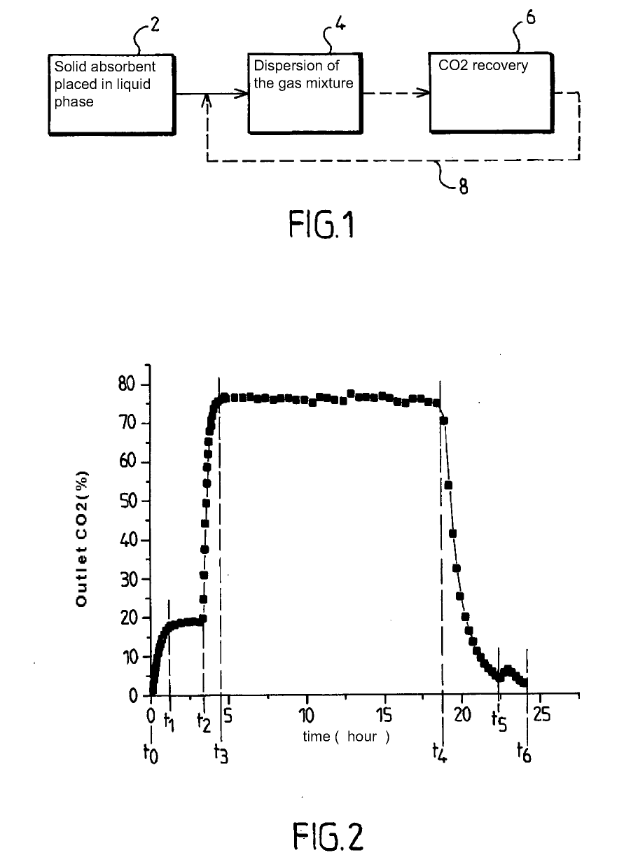

FIG. 1 is a schematic diagram of the inventive method,

FIG. 2 is a plot representing, as a function of time, CO₂ concentration in the outlet gas stream during capture and release phases by activated carbon,

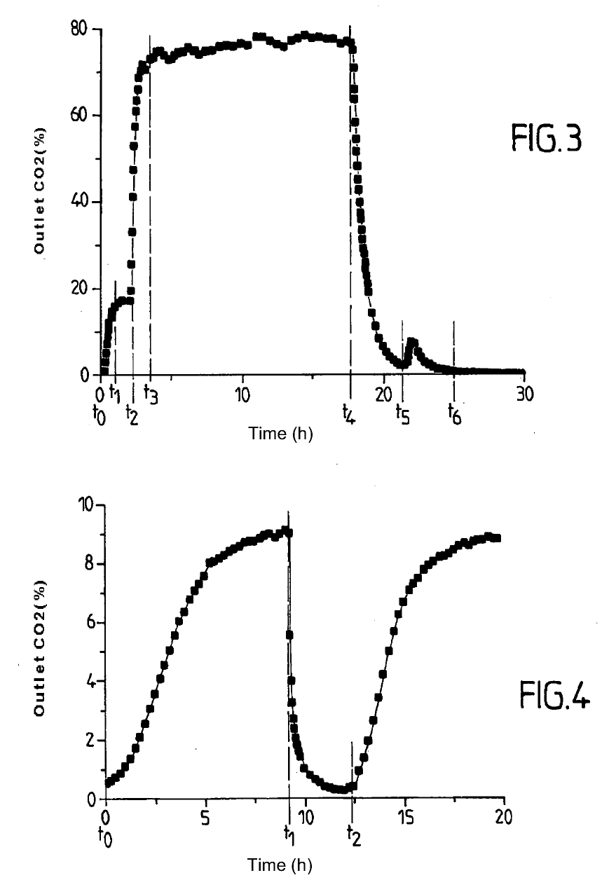

FIG. 3 is a plot representing, as a function of time, CO₂ concentration in the outlet gas stream during capture and release phases by a material rich in zeolite,

FIG. 4 is a plot representing, as a function of time, CO₂ concentration in the outlet gas stream during capture and release phases, repeated in an iterative fashion, by quintinite-3T which is a layered double hydroxide (LDH) material,

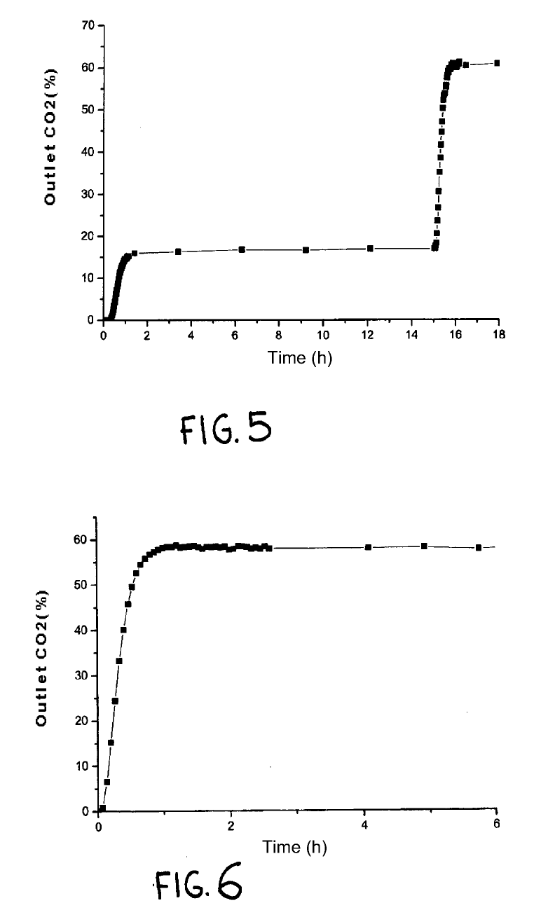

FIG. 5 is a plot representing, as a function of time, CO₂ concentration in the outlet gas stream during capture phases, by a calcium carbonate material, and,

FIG. 6 is a plot representing, as a function of time, CO₂ concentration in the outlet gas stream during capture phases, by a diatomite material.

According to the invention and as diagrammed in FIG. 1, the starting mixture is one of several gases, one of which is CO₂, and from this mixture it is desired to extract and trap the CO₂ and, optionally, return the CO₂ to purified form.

To this end, the method includes a first step 2 in which a solid absorbent suitable for trapping CO₂ is suspended in a liquid medium. It includes a second step 4 in which the gaseous mixture is dispersed in the liquid medium. In practise, the liquid medium is contained in a reactor equipped with an inlet for admitting the gas mixture and an outlet for extracting the gas mixture not captured after treatment or the carbon dioxide after release.

The first two stages 2 and 4 trap the CO₂ contained in the gas mixture.

In an advantageous embodiment, the method can include a third step 6 of CO₂ recovery. The CO₂ trapped in the trapping material can be released by reducing the partial pressure of CO₂ in the reactor's inlet, and/or by raising the temperature of the solid suspension and/or or by lowering total pressure in the capture reactor. If it is desired to extract purified CO₂, it is essential to completely close the reactor's gas inlet so that only carbon dioxide is released from the reactor's outlet.

In the context of an industrial method, the two steps 4 and 6 are repeated in an iterative fashion, as indicated by arrow 8, by opening and closing the reactor's inlet to produce at the reactor's outlet, when the gas inlet is closed, pure CO₂.

Several examples implementing the inventive method are described below.

### EXAMPLE 1

### Activated Carbon

A test was conducted to capture and then release CO₂ from a stream of an N₂/CO₂ gas mixture by a trap formed of activated carbon in suspension in an aqueous medium. The activated carbon used has a specific surface of 1500 m²/g.

The gas mixture introduced initially has an initial CO₂ content of 19% by volume which was then brought to 76% by volume. The treatment was carried out at a temperature of 15° C. and at atmospheric pressure.

The CO₂ content in the mixture at the reactor's outlet is represented in FIG. 2.

During a period between t0 (initial time) and t2, the CO₂ content in the gas mixture at the inlet is 19% by volume. It is noted that, during this period, the CO₂ content in the gas at the outlet slowly increases from 0% at t0 to 19% at t1, which indicates CO₂ capture by the trap, and then stabilisation at 19% between t1 and t2, which indicates that equilibrium is reached.

At t2, the inlet gas mixture is modified by bringing the CO₂ content to 76% by volume until t4. This change in CO₂ content is carried out in the context of a laboratory test. In an industrial process, it is in general not possible to carry out such a change in the gas mixture. It is noted that, as during the period t0-t2, the CO₂ content at the outlet slowly increases between t2 and t3, indicating CO₂ capture, and then stabilises at 76% by volume at t3 when a new equilibrium is reached.

The volumes of CO₂ captured for a CO₂ content of 19% and 76% account for, respectively, 0.5 mol CO₂/kg activated carbon and 0.77 mol CO₂/kg activated carbon.

It is further noted that capture is much better when the partial pressure of CO₂ in the gas mixture is high.

At t4, CO₂ is shut off to the reactor (only nitrogen is supplied). The release of captured CO₂ is then observed at the reactor's outlet until t5. The quantity of gas released is about 3.3 mol CO₂/kg activated carbon. This quantity is greater than that captured during the two capture phases. This is most probably due to the release of oxygenated groups present on the surface of the activated carbon before the tests.

When the temperature is raised to 60° C., an additional release of 0.18 mol residual CO₂/kg activated carbon is observed (cf. period t5-t6).

### EXAMPLE 2

### Zeolite

A test similar to the preceding test was performed by replacing the activated carbon by a material rich in zeolite whose specific surface is near 70 m²/g. FIG. 3 reveals the same type of plot as in the preceding test for the outlet content of CO₂:

period t0-t2: N₂/CO₂ mixture at 19% CO₂, reactor at 15° C.; CO₂ capture until equilibrium reached,

period t2-t4: N₂/CO₂ mixture at 76% CO₂, reactor at 15° C.; additional CO₂ capture until new equilibrium reached,

period t4-t5: no supply of CO₂, reactor at 15° C.; CO₂ release,

period t5-T6: no supply of CO₂, reactor at 60° C.; additional CO₂ release.

In this example, the volumes of CO₂ captured for CO₂ content of 19% and 76% are, respectively, 0.54 mol CO₂/kg zeolite and 2.08 mol CO₂/kg zeolite, which is a total quantity of 2.62 mol CO₂/kg zeolite. At t5, a release of 2.65 mol CO₂/kg zeolite is observed, which more or less corresponds to the captured portion. An additional release of 0.39 mol CO₂/kg zeolite is observed when the reactor is brought to a temperature of 60° C.

### EXAMPLE 3

### Quintinite-3T

Quintinite-3T is a layered double hydroxide (LDH) material.

The test was carried out with a solid absorbent having a specific surface of 80 m²/g placed in aqueous suspension in a reactor at 30° C. and at atmospheric pressure. The inlet gas is an N₂/CO₂ mixture, the CO₂ content being 9% by volume.

While the gas mixture is being supplied (period t0-t1 in FIG. 4), CO₂ is captured until equilibrium is reached. Under the test conditions, 0.49 mol CO₂/kg quintinite-3T is captured. Then, in the absence of a supply of CO₂ (period t1-t2 in FIG. 4), captured CO₂ is released. A release of 0.49 mol CO₂/kg quintinite-3T is observed, which corresponds to the captured portion.

In this test, the capture step was repeated by again supplying the reactor with the gas mixture. A capture of 0.67 mol CO₂/kg quintinite-3T is noted.

A test was also carried out with the same adsorbent at a temperature of 15° C. and at atmospheric pressure. The inlet gas was an N₂/CO₂ mixture, the CO₂ content being 16% by volume. A similar capture plot is observed, with a capture rate of 7.8 mol CO₂/kg adsorbent at equilibrium.

### EXAMPLE 4

### Precipitated Calcium Carbonate (PCC)

The test was carried out with a solid, precipitated calcium carbonate (PCC), placed in aqueous suspension in a reactor at 15° C. and at atmospheric pressure. The inlet gas is an N₂/CO₂ mixture, the initial CO₂ content of 16% by volume then being brought to 60%.

The results of measurements are presented in FIG. 5.

Volumes of captured CO₂ account for, respectively, 1.07 mol and 1.21 mol CO₂/kg carbonates, which is a total quantity of 2.27 mol of captured CO₂ per kg of carbonate. As for the other solids, it was shown that lowering the partial pressure of CO₂ led to a quantitative release of the CO₂ initially captured.

### EXAMPLE 5

### Diatomite

The test was carried out with a solid, diatomite, placed in aqueous suspension in a reactor at 15° C. and at atmospheric pressure. The inlet gas is an N₂/CO₂ mixture, the CO₂ content being initially 60% by volume.

The results of measurements are presented in FIG. 6.

The volume of captured CO₂ represents 1.38 mol of CO₂ per kg of diatomite. As for the other solids, it was shown that lowering the partial pressure of CO₂ led to a quantitative release of the CO₂ initially captured.

Thus, in the context of an industrial use of the method, it is noted that by a succession of capture/release cycles, each cycle including a step of supplying a gas mixture followed by a step supplying CO₂, or without supplying any gas, it is possible to extract CO₂ from a gas mixture while purifying it.

In the tests described above, carried out in the laboratory, nitrogen is constantly supplied to the reactor in order to better emphasise in FIGS. 2 to 6 the decreasing CO₂ content at the reactor's outlet, which represents its release.

In the context of an industrial use, the method could be used either to generate a pure stream of CO₂ or to generate a stream of gas enriched in CO₂. If a stream of pure CO₂ is sought, release of the captured gas will be obtained by increasing the temperature to at most 30° C. or by lowering the pressure, with the supply of the initial gas mixture having been stopped. If a stream of gas enriched in CO₂ is sought, then the circulation of the gas mixture to be treated is maintained and an increase in the temperature of the suspension to at most 30° C. will be sufficient to release the CO₂ initially captured.

Among the various absorbents that can be used in the inventive method, layered double hydroxides (LDHs) perform particularly well. In addition to the examples of quintinite-3T and hydrotalcite, those persons skilled in the art advantageously will be able to refer to the patent FR 2882549 which describes other examples of LDHs as well as a method for synthesising such materials.

The inventive method is thus particularly of interest from an industrial point of view. Indeed, it enables CO₂ trapping in a reversible manner without the need for methods that are energetically costly (large increase in temperature, evaporation of a liquid phase, solid/liquid separation, etc.) and without any handling of the suspension constituting the trap which remains in place in the capture/release reactor throughout the cycle. In addition, the method is performed under conditions of ambient pressure and temperature or near ambient conditions, with a slightly higher temperature favouring CO₂ release.

1-7. (canceled)

8. A method for separating the gaseous CO₂ contained in a gas mixture comprising:
a step of suspending in an aqueous medium a solid absorbent capable of capturing gaseous CO₂, and,
a step of dispersing the gas mixture in the liquid phase, said step being carried out at a temperature comprised between 0° C. and 30° C. and at a pressure comprised between atmospheric pressure and 3 bars, with the limits included.

9. The method according to claim 8, wherein the absorbent solid is selected equally among:
a carbonaceous material such as, for example, activated carbon or carbon nanotubes;
an oxide, for example silicates such as zeolites, clays, mesoporous silicas, manganese oxides, pumice, perlite or diatomite;
a phosphate or a phosphonate;
an hydroxide such as, for example, the layered double hydroxides such as quintinite-3T or hydrotalcite.

10. The method according to claim 8, including an additional step of recovering the captured gaseous CO₂.

11. The method according to claim 10, wherein said recovery step comprises a step of lowering the partial pressure of the gas to be trapped introduced into the liquid phase and/or by creating a weak vacuum pressure in the capture reactor.

12. The method according to claim 10, wherein said recovery step comprises a step of raising the temperature of the liquid phase.

13. The method according to claim 10, wherein the cycle formed by a dispersion step and a recovery step are repeated in an iterative fashion.

14. The method according to claim 9, including an additional step of recovering the captured gaseous CO₂.

15. The method according to claim 11, wherein said recovery step comprises a step of raising the temperature of the liquid phase.

16. The method according to claim 14, wherein said recovery step comprises a step of raising the temperature of the liquid phase.
